(19) United States
(12) Patent Application Publication
(10) Pub. No.: US 2010/0266229 A1
(43) Pub. Date: Oct. 21, 2010

(54) Aircraft Thrust Bearing Assembly, Method of Manufacture and Method of Use

(76) Inventors: Solly Melyon, Valdosta, GA (US); William M. Clapp, Valdosta, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/426,426

(22) Filed: Apr. 20, 2009

(51) Int. Cl. F16C 9/02; B21D 53/10

(52) U.S. Cl. 384/294; 29/898.041

(57) ABSTRACT

An aircraft thrust bearing assembly utilizing a U-shaped bearing disposed over a portion of a thrust bearing shaft, both within a housing that is mounted to the front of an engine utilized for driving an aircraft propeller. The thrust bearing shaft rides in the U-shaped bearing, wherein the U-shaped bearing separates the thrust bearing shaft from the housing. The front of the thrust bearing shaft has a mounting plate for attachment of a propeller, the mounting plate being machined to be perpendicular to the rotational axis of the thrust bearing shaft. The rear of the thrust bearing shaft comprises an outer surface adapted to receive a gear press-fitted thereon and an aperture within the shaft that is dimensioned to fixedly receive therewithin an end portion of the crankshaft of the engine being selected for propulsion of the aircraft.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to thrust bearings for aircraft engines, and more specifically to a thrust bearing with housing for installation on the crankshaft of an engine for an experimental aircraft.

2. Description of Related Art

Many aircraft enthusiasts enjoy and even prefer to construct their own aircraft, which are typically known as experimental aircraft. Often such aircraft utilize standard aircraft engines, but occasionally, other non-aircraft engines may be utilized.

Due to the need to simplify construction and cost, such enthusiast aircraft typically utilize air-cooled engines, rather than those cooled by glycol or other fluids. Accordingly, engines selected for use will often be chosen from the selection of available automotive air-cooled engines.

One such engine that has been adapted from automotive to aircraft use is the horizontally-opposed six-cylinder engine developed in the 1950s by the Chevrolet Division of General Motors for the Corvair automobile. This engine is particularly suited due to its lightweight aluminum crankcase/aluminum heads construction and air-cooled cylinders, resulting in improved airflow over the cylinder cooling fins and providing ready access for ease of maintenance. In fact, it may well be said that the Corvair engine is even more suited to aircraft use than for automobiles, because for aircraft use the engine does not require a blower to pass air over the cooling fins. Further, because of its construction, the Corvair engine may be readily adapted to use as an aircraft engine.

Aircraft engines require a thrust bearing to support the weight and loads of the rotating propeller, and this thrust bearing must prevent undue forces being exerted on the engine components to prevent untoward wear and deterioration. Typically, the engines utilized by enthusiasts for their experimental aircraft are direct drive; that is, the propeller is driven at the same rotation rate as the engine crankshaft and is connected directly to the crankshaft. Unfortunately, this direct drive construction, coupled with aircraft maneuvers, may result in gyroscopic, asymmetric and bending loads (as opposed to the torque loads for which the crankshaft is particularly designed) that have a deteriorative effect on the crankshaft, particularly causing it to crack. Accordingly, horsepower must be restricted to avoid such deterioration.

Therefore, it is readily apparent that there is a need for an aircraft thrust bearing assembly to overcome the aforementioned deficiencies for use in combination with engines that may not be traditionally utilized for aircraft.

### BRIEF SUMMARY OF THE INVENTION

Briefly described, in a preferred embodiment, the present invention overcomes the above-mentioned disadvantages and meets the recognized need for such a device by providing an aircraft thrust bearing assembly, a method of manufacture of same and a method of use of same, wherein the aircraft thrust bearing utilizes a U-shaped bearing disposed over a portion of a thrust bearing shaft, and wherein the U-shaped bearing and thrust bearing shaft are disposed within a housing that is mounted to the front of an engine utilized for driving an aircraft propeller, thereby extending and supporting the engine's crankshaft and permitting higher horsepower engines to be utilized. The thrust bearing shaft rides on the U-shaped bearing, wherein the U-shaped bearing separates the thrust bearing shaft from the housing. A suitable U-shaped bearing has been found to be the crankshaft bearing from a 350 cu. in. Chevrolet engine, although it will be recognized by those skilled in the art that other U-shaped bearings could be utilized along with the thrust bearing shaft of the preferred embodiment.

The front of the thrust bearing shaft has a mounting plate for attachment of a propeller, wherein the mounting plate is machined to be perpendicular to the rotational axis of the thrust bearing shaft. The rear of the thrust bearing shaft comprises an outer surface adapted to receive a gear press-fitted thereon, and an aperture within the shaft that is dimensioned to fixedly receive therewithin an end portion of the crankshaft of the engine being selected for propulsion of the aircraft. The crankshaft/thrust bearing combination, along with the aforementioned propeller mounting plate are ground by a crankshaft grinding machine once assembled to provide a combination having a true coincident rotational axis.

The preferred embodiment provides ease of assembly and ease of maintenance, while readily adapting a propeller to the engine. The housing is readily accessible for removal of the U-shaped bearing and/or thrust bearing shaft. The preferred embodiment provides a stable rotational thrust bearing assembly that facilitates adaptation of existing automobile (or other) engines for use with an aircraft.

According to its major aspects and broadly stated, the present invention in its preferred form is an aircraft thrust bearing assembly, a method of manufacture and a method of use, the thrust bearing assembly comprising a principal rotational axis, a front portion having a surface adapted for mounting a propeller thereto, wherein the surface is perpendicular to the principal rotational axis of the thrust bearing, a middle portion, a rear portion and a U-shaped bearing in rotational communication with the thrust bearing. The U-shaped bearing preferably comprises a split U-shaped bearing.

The thrust bearing is operatively connected to the engine's crankshaft. The thrust bearing has an aperture therethrough into which the crankshaft is secured via an interference fit. A gear is disposed on a rear portion of the thrust bearing and is operatively connected to a camshaft gear of the engine. The gear may alternately be machined on the rear portion of the thrust bearing or press-fit onto a gear land formed on the rear portion.

The thrust bearing is in rotational communication with the U-shaped bearing, which is retained within and by the housing, the housing being secured to the front of an aircraft engine. The thrust bearing comprises disc walls that define the middle portion thereof, and the middle portion is dimensioned to receive the U-shaped bearing. The housing and the U-shaped bearing restrain the disc walls of the thrust bearing from movement along the principal rotational axis of the thrust bearing.

The thrust bearing is manufactured by drilling an aperture in a metal blank core, machining a front portion, a middle portion, a rear portion, a first disc and a second disc on the metal blank core, thereby forming the thrust bearing. The thrust bearing is press-fit in interference fit to a crankshaft of an engine. The combination is then machined to final dimensions to ensure a true coincident rotational axis, and a mounting plate front surface is ground perpendicular to the rotational axis of the thrust bearing, wherein the front surface is adapted to receive an aircraft propeller. The gear may be machined integrally on the thrust bearing or press-fit on a gear land thereon.

The thrust bearing is installed directly on the crankshaft of the engine and a housing is installed around the thrust bearing. Disposed between the aircraft thrust bearing and the housing is a U-shaped bearing. The housing with thrust bearing and U-shaped bearing therein is installed on the aircraft engine.

To properly align during assembly, the left and right case halves of the engine are separated, the crankshaft is replaced with an alignment tool, the left and right engine case halves are reassembled together, and utilizing the alignment tool to support the housing, the housing is assembled on the engine with the left and right housing halves secured together around the alignment tool, the housing then being installed on the engine.

The aligned assembly is then separated into the left engine case half and the left housing half remaining secured thereto on the one hand, and the right engine case half and the right housing half remaining secured thereto on the other hand. The alignment tool is then removed and the thrust bearing with the crankshaft secured thereto is installed in the engine, and the engine case halves and housing halves are secured back together.

More specifically, the present invention is an aircraft engine with a thrust bearing assembly comprising a thrust bearing shaft, a U-shaped bearing, an oil seal, a housing and a gear. The thrust bearing shaft has a mounting plate for a propeller that is secured to the front of the mounting plate by fasteners.

The thrust bearing shaft is manufactured by drilling an aperture in a metal blank core. The front portion, middle portion, rear portion, first and second discs are formed by machining. A gear land to accommodate a gear to operatively couple with the engine's cam gear is machined, or, alternately, the gear may be integrally formed. The thrust bearing shaft is then press fit to the crankshaft, the combination is ground to final dimension to ensure a true coincident axis, and the mounting plate is ground to produce a front surface perpendicular to the rotational axis of the thrust bearing shaft.

The thrust bearing shaft has a front portion, a middle portion and a rear portion. The front portion and the middle portion are separated by a first disc wall and the middle portion and the rear portion are separated by a second disc wall. The disc walls define the limits of travel of the thrust bearing shaft on the U-shaped bearing, and retain the propeller, preventing same from pulling the thrust bearing assembly out of the engine under thrust load. The U-shaped bearing comprises, for exemplary purposes only, a split U-shaped bearing formed from a first bearing half and a second bearing half (such as, for exemplary purposes only, a Chevrolet 350 cu. in. engine crankshaft U-shaped bearing) that together form the U-shaped bearing that is disposed around the middle portion of the thrust bearing shaft.

The rear portion of the thrust bearing shaft has a gear land thereon, onto which a gear is press fit. The rear portion also has an aperture therein that is dimensioned to fixedly receive an engine crankshaft in interference fit.

The housing comprises a left housing half and a right housing half that are assembled together and secured by fasteners around the thrust bearing shaft, U-shaped bearing and oil seal, thereby securing the shaft, U-shaped bearing and oil seal within the housing. The housing is dimensioned to mate with the front of the engine, being secured to same via fasteners.

The housing also has a front, a rear, an oil seal seat, a front opening, a rear opening, an oil feed opening, an oil feed line, an oil drain, a bearing opening and a bearing riding surface. The bearing riding surface dimensionally restrains the U-shaped bearing once the housing is in place around the thrust bearing shaft with the U-shaped bearing installed thereon. Oil is fed via the oil feed line from an oil reservoir to the oil feed opening to lubricate the U-shaped bearing and the thrust bearing shaft. Excess oil drains away via the oil drain.

In use, a gear is press fit onto the thrust bearing shaft at the gear land, and the engine crankshaft is inserted into the aperture and secured therewithin by an interference fit. The oil seal halves are disposed within the oil seal seat of the housing. The first and second halves of the U-shaped bearing are disposed around the middle portion of the thrust bearing shaft and the housing halves are secured together and to the engine. A propeller is then secured to the mounting plate of the thrust bearing shaft via fasteners. The gear engages a cam gear that is disposed on the engine's camshaft. Thus rotation of the crankshaft and camshaft are operationally coupled.

To ensure proper alignment of the aircraft thrust bearing assembly, an alignment tool replaces the crankshaft and is utilized to support the housing, prior to, and during, assembly of the housing to the engine. Accordingly, the alignment tool is installed in the engine, replacing the engine's crankshaft and the left and right engine case halves are secured together. The left and right housing halves are secured together around the alignment tool and the housing is subsequently installed to the engine. Once the housing is aligned, the engine case half with the left housing half secured thereto is separated from the engine case half with the right housing half secured thereto, and the alignment tool is removed. Finally, the crankshaft with the thrust bearing assembly press fit thereon is installed in the engine, and the engine case halves and housing halves are secured together.

Accordingly, a feature and advantage of the present invention is its ability to adapt a propeller to an existing engine while providing support to the propeller and while reducing deteriorative forces on the engine.

Another feature and advantage of the present invention is its ability to be readily removed and replaced within its housing.

Still another feature and advantage of the present invention is its ability to utilize existing standard wearable components.

Yet another feature and advantage of the present invention is that it provides for lubrication of the thrust bearing and U-shaped bearing.

Yet still another feature and advantage of the present invention is that it provides for accurate alignment of the thrust bearing, crankshaft and propeller combination.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred Embodiment with reference to the accompanying drawing figures, in which like reference numerals denote similar structure and refer to like elements throughout, and in which:

FIG. 1 depicts a cutaway perspective view of an engine with a thrust bearing and housing according to a preferred embodiment;

FIG. 2 is a front view of a housing component according to a preferred embodiment;

FIG. 3 is a side view of a left housing component according to a preferred embodiment;

FIG. 4 is a side view with partial cross-sectional view of a thrust bearing with housing according to a preferred embodiment shown installed on an engine crankshaft;

FIG. 5 depicts a side view of a thrust bearing component according to a preferred embodiment; and

FIG. 6 is an exploded perspective view of a housing with split U-shaped bearing and oil seal according to a preferred embodiment.

### DETAILED DESCRIPTION OF THE PREFERRED EMBODIMENT OF THE INVENTION

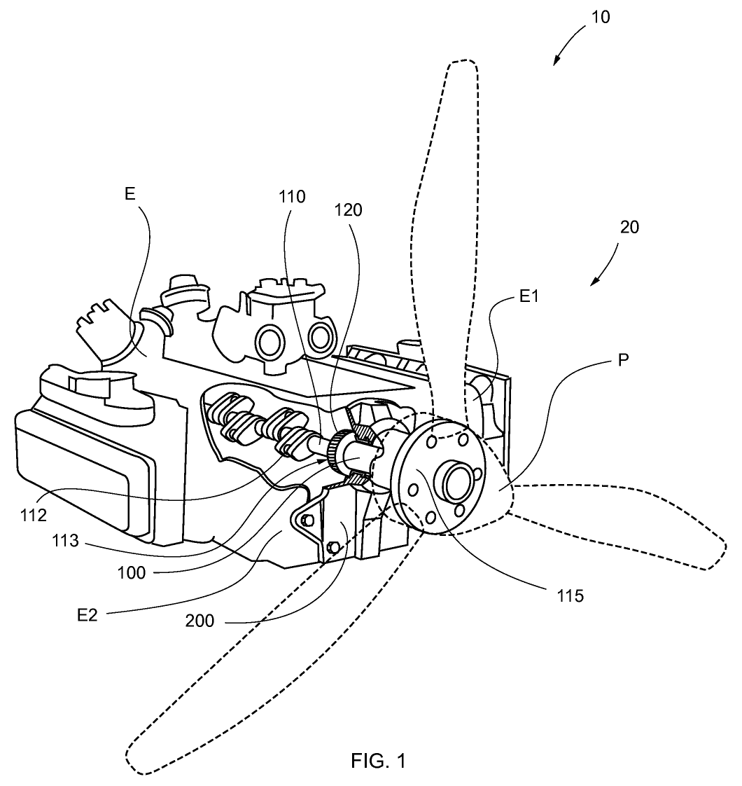

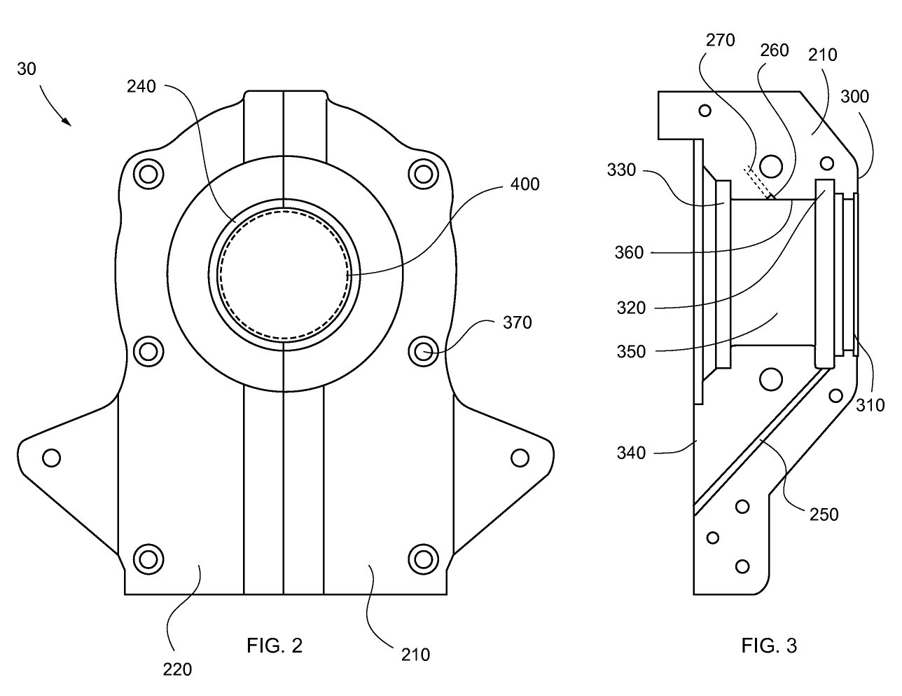

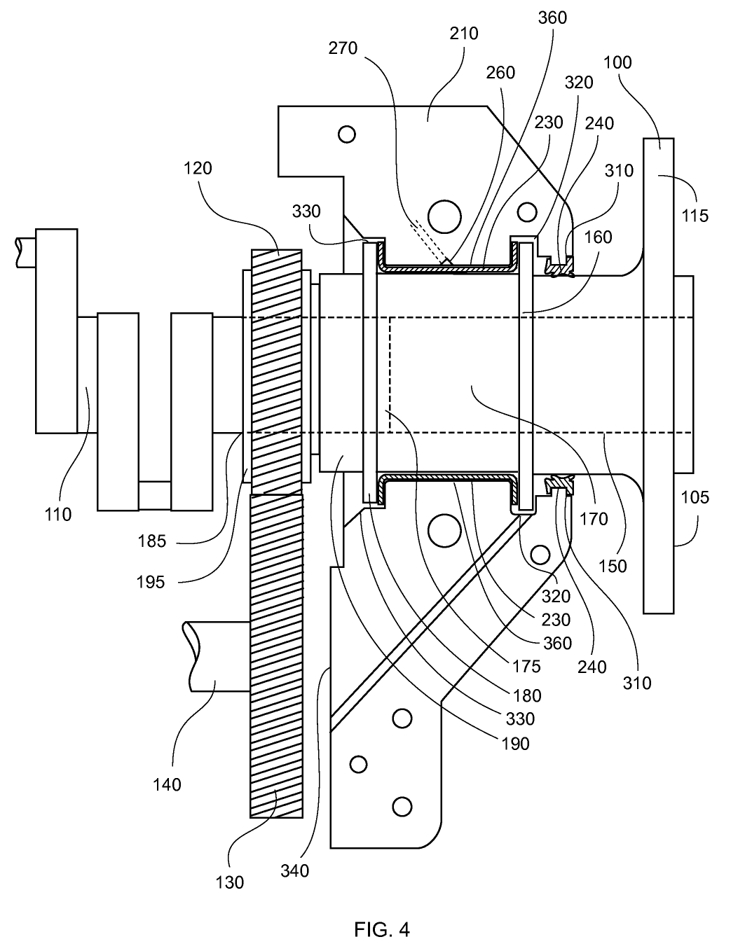

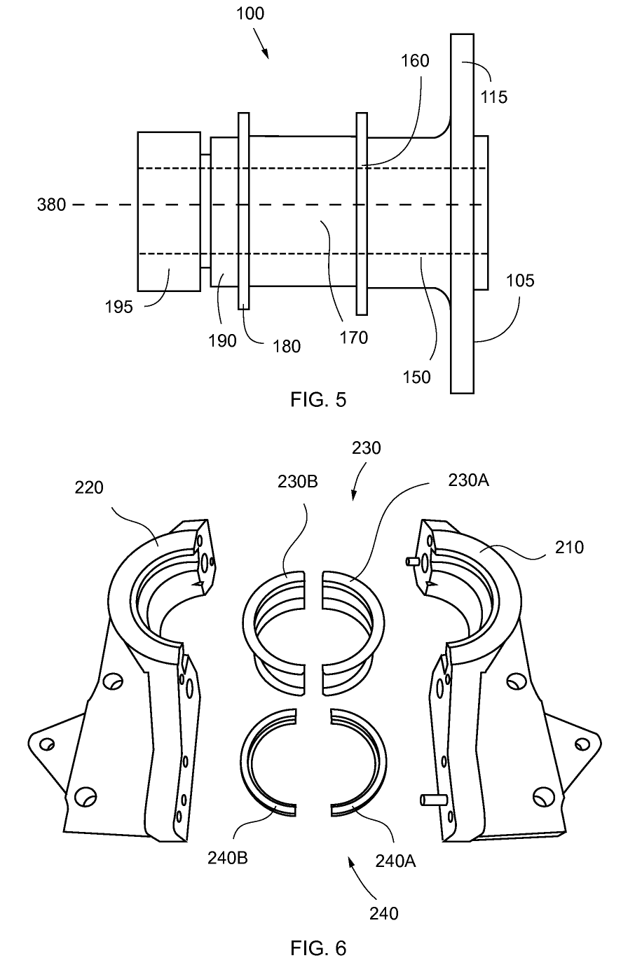

In describing the preferred embodiment of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-6, the present invention in a preferred embodiment is aircraft engine 10 with thrust bearing assembly 20, a method of manufacture and a method of use, wherein aircraft thrust bearing assembly 20 comprises thrust bearing shaft 100, U-shaped bearing 230, oil seal 240, housing 30 and gear 120, and wherein thrust bearing shaft 100 comprises mounting plate 115 for propeller P, and wherein propeller P is secured to front 105 of mounting plate 115 via suitable fasteners as are known in the art for securing aircraft propellers to thrust bearings.

Thrust bearing shaft 100 further comprises front portion 150, middle portion 170 and rear portion 190, wherein front portion 150 and middle portion 170 are separated by first disc wall 160, and wherein middle portion 170 and rear portion 190 are separated by second disc wall 180. First disc wall 160 and second disc wall 180 define the limits of travel of, and retain, thrust bearing shaft 100 within housing 30 on U-shaped bearing 230, thereby preventing propeller P from being pulled out of the engine due to its thrust loads. U-shaped bearing 230 comprises, for exemplary purposes only, a split U-shaped bearing having first bearing half 230A and second bearing half 230B, wherein bearing halves 230A, 230B together form U-shaped bearing 230 when bearing halves 230A, 230B are disposed around middle portion 170 of thrust bearing shaft 100. U-shaped bearing 230 is supported and fixedly maintained by its contact with housing 30. It has been found that a Chevrolet 350 cu. in. engine crankshaft U-shaped bearing is well suited as U-shaped bearing 230, but any suitable U-shaped bearing could be utilized without departing from the spirit of the preferred embodiment.

Rear portion 190 of thrust bearing shaft 100 comprises gear land 195, wherein gear 120 is press fit onto gear land 195. It will be recognized by those skilled in the art that gear 120 could be machined into rear portion 190 instead of being a separate component. Rear portion 190 further comprises aperture 175, wherein aperture 175 is dimensioned to fixedly receive crankshaft 110 via an interference fit through entrance 185. Aperture 175 continues throughout thrust bearing shaft 100, thereby facilitating accommodation of hydraulic or electric constant speed propellers as propeller P.

Thrust bearing shaft 100 is manufactured by drilling aperture 175 in a metal blank core. Front portion 150, middle portion 170 and rear portion 190 are formed by machining to near final dimensions, such as, for exemplary purposes only, on a CNC lathe, and first disc 160, second disc 180, and gear land 195 are also similarly formed by machining. Gear 120 may alternately be integrally formed. Thrust bearing shaft 100 is press fit to crankshaft 110 after first removing the original gear with bushing that would ordinarily engage the camshaft gear 130, crankshaft 110 with thrust bearing shaft 100 secured thereon is ground on a crankshaft grinding machine as more fully detailed hereinbelow, and finally, mounting plate 115 is ground to produce front surface 105 that is perpendicular to rotational axis 380 of thrust bearing shaft 100.

Housing 30 comprises left housing half 210 and right housing half 220, wherein left and right housing halves 210, 220 are assembled together around thrust bearing shaft 100, U-shaped bearing 230 and oil seal 240, securing same within housing 30. Housing 30 is dimensioned to secure to engine E via fasteners 370. Additionally, housing halves 210, 220 are secured together via fasteners (not shown).

Housing 30 further comprises front 300, rear 340, oil seal seat 310, front opening 320, rear opening 330, oil feed opening 260, oil feed line 270, oil drain 250, bearing opening 350 and bearing riding surface 360, wherein bearing riding surface 360 is dimensioned to receive U-shaped bearing 230 once housing 30 is in place around thrust bearing shaft 100 with U-shaped bearing 230 installed thereon. Front opening 320 and rear opening 330 further restrain thrust bearing shaft 100 from movement along principal rotational axis 380, thereby preventing propeller thrust from pulling thrust bearing 20 out of housing 30. Bearing riding surface 360 provides a surface for rotational communication between U-shaped bearing 230 and thrust bearing shaft 100. Oil is fed via oil feed line 270 from an oil reservoir (not shown) to oil feed opening 260, thereby lubricating U-shaped bearing 230 and thrust bearing shaft 100. Excess, or spent, oil subsequently drains away via oil drain 250 to a sump (not shown).

In use, gear 120 is press fit onto thrust bearing shaft 100 at gear land 195, existing gear bushing 113 is removed from existing crankshaft 110, and crankshaft 110 is subsequently inserted into aperture 175 via entrance 185, wherein crankshaft 110 is secured within aperture 175 by an interference fit. It will be recognized by those skilled in the art that other means for securing crankshaft 110 within thrust bearing shaft 100 could be utilized without departing from the spirit of the preferred embodiment.

Crankshaft 110 with thrust bearing shaft 100 secured thereon is subsequently turned in a crankshaft grinding machine, wherein crankshaft lobes 112 and middle portion 170 of thrust bearing shaft 100 are turned to final dimensions while in true and final alignment to form a coincident rotational axis 380.

First and second halves 230A, 230B of U-shaped bearing 230 are disposed around middle portion 170 of thrust bearing shaft 100. Oil seal halves 240A, 240B are disposed within oil seal seat 310 of housing 30. Left half 210 and right half 220 of housing 30 are disposed around thrust bearing shaft 100, wherein halves 210, 220 are secured together. Housing 30 is secured to engine E. Propeller P is secured to mounting plate 115 of thrust bearing shaft 100 via suitable fasteners as are known in the art.

To facilitate a properly aligned assembly, alignment tool 400 replaces crankshaft 110 and is utilized to support housing 30, prior to, and during, assembly of housing 30 to engine E. Accordingly, alignment tool 400 is installed in engine E, replacing crankshaft 110, wherein left and right engine case halves El and E2, respectively, are secured together. Left half 210 and right half 220 are secured together and housing 30 is subsequently secured to engine E around alignment tool 400. Once housing 30 is aligned, engine case half El with left half 210 secured thereto is separated from engine case half E2 with right half 220 secured thereto, and alignment tool 400 is removed. Finally, crankshaft 110 with thrust bearing shaft 100 thereon is installed in engine E, and case halves E1, E2 and housing halves 210, 220 are secured together. It will be recognized that housing halves 230A, 230B could be integrally formed as part of their respective case halves E1, E2.

Gear 120 engages camshaft gear 130, wherein camshaft gear 130 is disposed on camshaft 140 of engine E, and wherein rotation of crankshaft 110 and camshaft 140 are thus operationally coupled. So equipped with thrust bearing assembly 20 and propeller P, engine E may be utilized to propel an aircraft.

Although particularly suited to retrofit existing engines, thrust bearing assembly 20 could be incorporated as part of an originally-manufactured engine. Further, thrust bearing shaft 100 and crankshaft 110 could be formed as a unit from a single core.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A thrust bearing for an aircraft engine, said thrust bearing comprising:
a principal rotational axis;
front portion having a surface adapted for mounting a propeller thereto, wherein said surface is perpendicular to said principal rotational axis of said thrust bearing;
a middle portion;
a rear portion; and
a U-shaped bearing in rotational communication with said thrust bearing, and wherein said U-shaped bearing is disposed on said middle portion.

2. The thrust bearing of claim 1, wherein said U-shaped bearing is a split U-shaped bearing.

3. The thrust bearing of claim 1, wherein a gear is disposed on said rear portion of said thrust bearing, and wherein said gear is operatively connected to a camshaft gear.

4. The thrust bearing of claim 3, wherein said gear is machined on said rear portion.

5. The thrust bearing of claim 3, wherein said gear is press-fit onto a gear land formed on said rear portion.

6. The thrust bearing of claim 1, further comprising an oil seal.

7. The thrust bearing of claim 1, wherein said thrust bearing is operatively connected to an engine crankshaft, and wherein said thrust bearing and said engine crankshaft are aligned, and wherein said middle portion of said thrust bearing and said engine crankshaft are machined to final dimensions with a coincident axis once aligned.

8. The thrust bearing of claim 7, further comprising an aperture therethrough.

9. The thrust bearing of claim 8, wherein said crankshaft is secured via an interference fit into said aperture.

10. The thrust bearing of claim 1, wherein said thrust bearing is disposed within a housing, and wherein said housing is secured to said aircraft engine.

11. The thrust bearing of claim 10, wherein said U-shaped bearing is retained within and by said housing.

12. The thrust bearing of claim 11, wherein said thrust bearing is in rotational communication with said U-shaped bearing.

13. The thrust bearing of claim 12, wherein said thrust bearing comprises disc walls that define said middle portion, and wherein said middle portion is dimensioned to receive said U-shaped bearing.

14. The thrust bearing of claim 13, wherein said housing and said U-shaped bearing restrain said disc walls of said thrust bearing from movement along said principal rotational axis.

15. An aircraft engine comprising the thrust bearing of claim 1.

16. A method of manufacture of an aircraft thrust bearing, said method comprising the steps of:
drilling an aperture in a metal blank core;
machining a front portion, a middle portion, a rear portion, a first disc and a second disc on said metal blank core to form a thrust bearing;
press-fitting said thrust bearing to said crankshaft of an engine;
grinding said crankshaft and said thrust bearing together to result in a coincident rotational axis;
grinding a mounting plate front surface perpendicular to said rotational axis of said thrust bearing, wherein said front surface is adapted to receive an aircraft propeller; and
disposing a U-shaped bearing in rotational communication with said middle portion.

17. The method of manufacture of claim 16, said method further comprising the step of:
machining a gear integrally on the thrust bearing.

18. The method of manufacture of claim 16, said method further comprising the step of:
machining a gear land on said thrust bearing to accommodate a gear press-fit thereon.

19. The method of manufacture of claim 16, said method comprising the step of:
removing an existing gear bushing from an engine crankshaft.

20. A method of use of an aircraft thrust bearing, said method comprising:
installing said aircraft thrust bearing directly to a crankshaft of an engine;
installing a housing around said thrust bearing;
disposing a U-shaped bearing between said aircraft thrust bearing and said housing; and
installing said housing on said engine.

21. The method of claim 20, said method further comprising the steps of:
separating left and right case halves of said engine;
replacing said crankshaft of said engine with an alignment tool;
securing said left and right engine case halves together;
utilizing said alignment tool to support said housing, prior to, and during, assembly of said housing to said engine;
securing left and right housing halves together around said alignment tool;
installing said housing to said engine;
once aligned, separating said left engine case half having said left housing half secured thereto from the right engine case half having the right housing half secured thereto;
removing said alignment tool;
installing said thrust bearing having said crankshaft secured thereto in said engine; and
securing said engine case halves and said housing halves together.
